(19) United States
(12) Patent Application Publication
(10) Pub. No.: US 2006/0130641 A1
(43) Pub. Date: Jun. 22, 2006

(54) Apparatus and method for providing a twin piano function

(75) Inventor: Kazuo Kurahashi, Iwata-city (JP)

Correspondence Address: FOLEY & LARDNER, 2029 CENTURY PARK EAST, SUITE 3500, LOS ANGELES, CA, 90067, US

(73) Assignee: ROLAND CORPORATION

(21) Appl. No.: 11/296,647

(22) Filed: Dec. 6, 2005

(30) Foreign Application Priority Data
Dec. 9, 2004 (JP) 2004-356578
Dec. 17, 2004 (JP) 2004-365504

(51) Int. Cl. G10H 3/12; G10H 1/18

(52) U.S. Cl. 84/742

(57) ABSTRACT

An electronic instrument has a plurality of keys and allows a user to select one mode of a normal mode and a divided mode. Upon selecting of the normal mode, musical tones having a first set of characteristics are assigned to a single keyboard zone spanning the plurality of keys. Upon selecting of the divided mode, the single keyboard zone is divided into a plurality of keyboard zones, and musical tones having a second set of characteristics different from the first set of characteristics are assigned to each of the plurality of keyboard zones. A musical tone is generated upon operation of one key of the plurality of keys. The musical tone is generated in conformance with the selected mode. The musical tone may be output to a first output and/or a second output.

### BACKGROUND OF THE INVENTION

1. Field of the Invention

Embodiments of the present invention relate, generally, to an electronic instrument and, in particular, to an electronic instrument in which it is possible to divide one keyboard zone into a plurality of keyboard zones.

2. Related Applications

The present disclosure relates to Japanese Patent Application JP No. 2004-356578, filed on Dec. 9, 2004, and Japanese Patent Application JP No. 2004-365504, filed on Dec. 17, 2004, from which priority is claimed. Each is incorporated herein by entirety.

### RELATED ART

For some time, electronic instruments have been known to have a split capability by which it is possible to divide one keyboard zone into a plurality of keyboard zones and to set each of pitch, timbre, and assigned positions (panning) of musical tones corresponding to each of the plurality of keyboard zones.

In Japanese Laid-Open Patent Application Publication (Kokai) Number 2000-20063 (Patent Reference 1), an electronic instrument is disclosed in which it is possible to set a four-hand performance mode in which an ensemble performance is performed by two people on a single keyboard. In this four-hand performance mode, characteristics of musical tones that are played, such as the register and the timbre, are set for each of the keyboard zones.

In addition, in Japanese Patent Publication Number 3459844 (Patent Reference 2), an electronic instrument is disclosed. The disclosed electronic instrument uses a keyboard system that has been configured such that a touch for a first key having a pitch is heavier than a touch for a second key having a pitch that is higher than the pitch of the first key. A detected key pressing speed is converted to a velocity value that is transmitted to a sound source. If the velocity values produced by the first and the second keys are equivalent to each other, the velocity value produced by the first key is converted such that the velocity value produced by the first key is increased in relation to the velocity value produced by the second key.

However, since the purpose of the electronic instrument that is disclosed in Patent Reference 1 is to facilitate a four-hand performance, Patent Reference 1 does not consider a scenario in which each of a plurality of users uses a single keyboard independently. Therefore, in situations where each of a plurality of users tries to independently perform on a single keyboard, there has been a problem that musical tones that are played by a user performing in one keyboard zone hinder another user or users. Therefore, satisfactory practice cannot be conducted.

In addition, a so-called electronic piano can be configured such that, as in an acoustic piano, the touch is heavy for keys (in a keyboard zone) having pitches that are low relative to pitches of keys in other keyboard zones. In the case of the acoustic piano, this is because, as the pitch becomes lower, the strings becomes thicker and the masses of the hammers that hit the strings become greater. In an electronic instrument, the increase of mass is not necessary. However, in order to avoid creating a playing touch different from that of the acoustic piano, the electronic piano is configured such that the touch becomes heavier for keys having pitches that are low in relation to pitches of other keys. In such an electronic instrument, in those cases where the keyboard zone is divided into a plurality of keyboard zones and performances are carried out in each of these zones, there has been the problem that, in the case where a user plays in a keyboard zone having pitches that are low, a large key pressing force is needed. Therefore, the playing may become difficult.

In addition, in the electronic instrument that is disclosed in Patent Reference 2, even when a user uses a weak key pressing force in a keyboard zone having pitches that are low, a musical tone is formed having a high volume. This produces a situation different from that produced in an acoustic piano, and therefore the playing may become difficult.

Embodiments of the present invention address the problems discussed above and provide an electronic instrument that can be suitably used in those cases where a keyboard zone is used as a single keyboard zone and also in those cases where the keyboard zone is divided such that each of a plurality of users plays on a corresponding divided keyboard zone.

### SUMMARY OF THE DISCLOSURE

According to one embodiment of the present invention, an electronic instrument comprises a plurality of keys and mode selection means for selecting one mode of a normal mode and a divided mode. Upon selecting of the normal mode, musical tones having a first set of characteristics are assigned to a single keyboard zone spanning the plurality of keys. Upon selecting of the divided mode, the single keyboard zone is divided into a plurality of keyboard zones, and musical tones having a second set of characteristics different from the first set of characteristics are assigned to each of the plurality of keyboard zones. The electronic instrument also comprises musical tone generation means for generating a musical tone upon operation of one key of the plurality of keys. The musical tone is generated in conformance with the one mode selected by the mode selection means. The electronic instrument also comprises first output means for outputting the musical tone generated by the musical tone generation means to a first headphone. The electronic instrument also comprises second output means for outputting the musical tone generated by the musical tone generation means to a sound emitting means different from the first output means. The electronic instrument also comprises feed means for feeding the musical tone generated by the musical tone generation means from the musical tone generation means to at least one of the first output means and the second output means. Upon selecting of the normal mode by the mode selection means, the musical tone generated by the musical tone generation means is fed to the at least one of the first output means and the second output means. Upon the selecting of the divided mode by the mode selection means, the musical tone generated by the musical tone generation means is fed to the first output means if the one key of the plurality of keys is in a first keyboard zone of the plurality of keyboard zones and is fed to the second output means if the one key of the plurality of keys is in a second keyboard zone of the plurality of keyboard zones.

Therefore, there is the advantageous result that a performer who plays on one keyboard zone is not interfered by musical tones that have been played on another keyboard zone. Therefore, the electronic instrument is suitable for use in those cases where a single keyboard zone is divided into a plurality of keyboard zones and playing is done by a plurality of people using each of the keyboard zones.

In a further embodiment, the second output means outputs the musical tone generated by the musical tone generation means to a second headphone. The feed means, upon the selecting of the normal mode by the mode selection means, feeds the musical tone generated by the musical tone generation means to the first output means and the second output means. Thus, a performer who listens to a musical tone that has been output by the first output means does not hear a musical tone that is output by the second output means. Thus, it is possible to play under more satisfactory conditions.

In another further embodiment, the feed means, upon the selecting of the divided mode by the mode selection means, combines (1) a first musical tone that has been played using the first keyboard zone and having a first volume level and (2) a second musical tone that has been played using the second keyboard zone and having a second volume level and feeds the combined musical tones to the at least one of the first and the second output means. The second volume level is lower than the first volume level. Thus, there is the advantageous result that it is possible to play while listening to the playing that is carried out in another keyboard zone. For example, in those cases where the mother carries out the playing practice in one keyboard zone and a child carries out a playing practice in another keyboard zone, it is possible for the mother to listen to the child's playing practice at a low level and coach the child.

In another embodiment of the present invention, an electronic instrument comprises a plurality of keys. A key pressing force required to press down a first key is greater than a key pressing force required to press down a second key, when the first key has a lower pitch than the second key. The electronic instrument also comprises mode selection means for selecting one mode of a normal mode and a divided mode. Upon selecting of the normal mode, musical tones having a first set of characteristics are assigned to a single keyboard zone spanning the plurality of keys. Upon selecting of the divided mode, the single keyboard zone is divided into a plurality of keyboard zones, and musical tones having a second set of characteristics different from the first set of characteristics are assigned to each of the plurality of keyboard zones. The electronic instrument also comprises musical tone generation means for generating a musical tone upon operation of one key of the plurality of keys, wherein the musical tone is generated in conformance with the one mode selected by the mode selection means. The electronic instrument also comprises key pressing speed detection means for detecting a pressing speed of the one key of the plurality of keys and velocity value setting means for setting a velocity value in conformance with the pressing speed detected by the key pressing speed detection means. Upon selecting of the divided mode by the mode selection means, the velocity value is set to a first value, and, upon selecting of the normal mode by the mode selection means, the velocity value is set to a second value. If the one key is in a lower of the plurality of keyboard zones, the first value is greater than the second value. The electronic instrument also comprises transmitting means for transmitting the velocity value set by the velocity value setting means to the musical tone generation means.

Thus, there is the advantageous result that in those cases where playing is done in a register having a pitch that is low, it is possible for the playing to be done with a key pressing force that is the same as that of the case in which the playing is done in a register having a pitch that is high.

In a further embodiment, the electronic instrument also comprises register setting means. Upon selecting of the divided mode by the mode selection means, the register setting means assigns at least one register to at least one of the plurality of keyboard zones. The at least one register is different from a register assigned by the register setting means upon selecting of the normal mode by the mode selection means. Thus, it is possible to play with the same key pressing force as in the case where the playing is done in a register having a pitch that is high and, together with this, a musical tone is formed that has a volume that corresponds to the key pressing force.

In a further embodiment, the electronic instrument also comprises dividing position setting means for setting ad libitum dividing positions at which the single keyboard zone is divided into the plurality of keyboard zones. The register setting means assigns the at least one register in conformance with the dividing positions set by the dividing position setting means. Thus, there is the advantageous result that in those cases where the points of division are set ad libitum, the optimum registers are assigned to the divided keyboard zones.

In a further embodiment, the velocity value setting means converts the pressing speed to the velocity value in conformance with the operation of the one key of the plurality of keys and a pitch of the musical tone generated by the musical tone generation means. Thus, there is the advantageous result that, in the divided mode, it is possible to make the key pressing force with which the key is pressed down and the pitch of the musical tone that is generated conform to a higher degree.

In a further embodiment, the electronic instrument also comprises first output means for outputting the musical tone generated by the musical tone generation means to a first headphone. The electronic instrument also comprises second output means for outputting the musical tone generated by the musical tone generation means to a sound emitting means different from the first output means. The electronic instrument also comprises feed means for feeding the musical tone generated by the musical tone generation means from the musical tone generation means to at least one of the first output means and the second output means. Upon the selecting of the normal mode by the mode selection means, the musical tone generated by the musical tone generation means is fed to the at least one of the first output means and the second output means. Upon the selecting of the divided mode by the mode selection means, the musical tone generated by the musical tone generation means is fed to the first output means if the one key of the plurality of keys is in a first keyboard zone of the plurality of keyboard zones and is fed to the second output means if the one key of the plurality of keys is in a second keyboard zone of the plurality of keyboard zones. Therefore, there is the advantageous result that the electronic instrument is suitable for those cases in which a single keyboard zone is divided into a plurality of keyboard zones and a plurality of people carry out performances using each of the keyboard zones without the musical tones that have been played using a keyboard zone or zones interfering with a performer who is carrying out a performance using another of the keyboard zones.

In a further embodiment, the second output means outputs the musical tone generated by the musical tone generation means to a second headphone. The feed means, upon the selecting of the normal mode by the mode selection means, feeds the musical tone generated by the musical tone generation means to the first output means and the second output means. Compared to the case in which the musical tones that have been output by the second output means are emitted by means of a speaker, the performer who listens to the musical tones that have been output by the first output means does not hear the musical tones that are output by the second output means and it is possible to play under more satisfactory conditions.

In a further embodiment, the feed means, upon the selecting of the divided mode by the mode selection means, combines (1) a first musical tone that has been played using the first keyboard zone and having a first volume level and (2) a second musical tone that has been played using the second keyboard zone and having a second volume level and feeds the combined musical tones to at least one of the first and the second output means. The second volume level is lower than the first volume level. Thus, there is the advantageous result that it is possible to play while listening to the playing that is carried out in another keyboard zone. For example, in those cases where a mother carries out the playing practice in one keyboard zone and a child carries out a playing practice in another keyboard zone, it is possible for the mother to listen to the child's playing practice at a low level and coach the child.

In another embodiment of the present invention, an electronic instrument comprises a plurality of keys. A key pressing force required to press down a first key is greater than a key pressing force required to press down a second key, the first key having a lower pitch than the second key. The electronic instrument also comprises key pressing speed detection means for detecting a pressing speed of an operated key of the plurality of keys and pitch detection means for detecting a pitch assigned to the operated key. The electronic instrument also comprises musical tone generation means for generating a musical tone based on the pressing speed detected by the key pressing speed detection means and the pitch detected by the pitch detection means. The electronic instrument also comprises pitch assignment changing means for changing the pitch detected by the pitch detection means. The electronic instrument also comprises velocity value setting means for setting a velocity value based on the pressing speed detected by the key pressing speed detection means and based on the pitch detected by the pitch detection means and the pitch changed by the pitch assignment changing means. The electronic instrument also comprises transmitting means for transmitting the pitch changed by the pitch assignment changing means and the velocity value set by the velocity value setting means to the musical tone generation means.

Thus, there is the advantageous result that, even in those cases where the pitch that is assigned to the key has changed, it is possible to play with a key pressing force that corresponds to the pitch that has been assigned.

In another embodiment of the present invention, an electronic instrument comprises a plurality of keys and mode selection means for selecting one mode of a normal mode and a divided mode. Upon selecting of the normal mode, musical tones having a first set of characteristics are assigned to a single keyboard zone spanning the plurality of keys. Upon selecting of the divided mode, the single keyboard zone is divided into a plurality of keyboard zones, and musical tones having a second set of characteristics different from the first set of characteristics are assigned to each of the plurality of keyboard zones. The electronic instrument also comprises musical tone generation means for generating a musical tone upon operation of one key of the plurality of keys, wherein the musical tone is generated in conformance with the one mode selected by the mode selection means. The electronic instrument also comprises dividing position setting means for, upon selecting of the divided mode by the mode selection means, setting ad libitum dividing positions at which the single keyboard zone is divided into the plurality of keyboard zones. The electronic instrument also comprises register setting means for assigning registers to each of the plurality of keyboard zones in conformance with the dividing positions set by the dividing position setting means.

Thus, there is the advantageous result that, by the performer merely setting the dividing positions, the registers are assigned to each of keyboard zones in conformance with the dividing positions that have been set. Therefore, operation is simple without the need for setting the registers in each of the keyboard zones.

### BRIEF DESCRIPTION OF THE DRAWINGS

FIG. 1 is a block diagram of an electrical configuration of the electronic instrument according to a preferred embodiment of the present invention;

FIG. 2(a) is a drawing that shows an operating panel of the electronic instrument;

FIG. 2(b) is a drawing that shows a set of pedals of the electronic instrument;

FIG. 3 is a circuit diagram that shows a sound production channel;

FIG. 4 is a lateral view drawing of a keyboard;

FIG. 5 is a flowchart showing main processing executed by a CPU of the electronic instrument;

FIG. 6 is a flowchart showing sound production processing that is executed by the CPU;

FIG. 7 is a flowchart showing pedal processing that is executed by the CPU;

FIG. 8 is a graph that shows touch curves; and

FIG. 9 is a shift table that shows values by which a note number is shifted when the electronic instrument is operating in a divided mode.

### DETAILED DESCRIPTION OF PREFERRED EMBODIMENTS

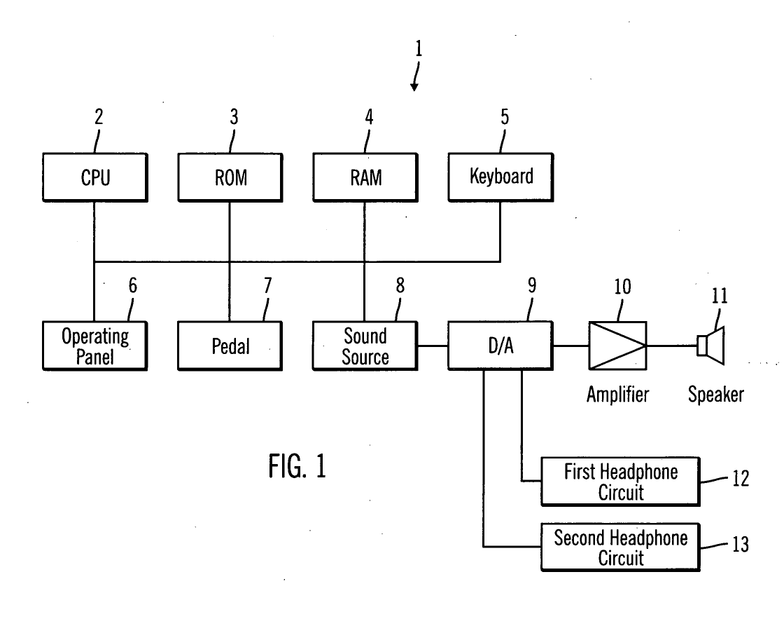

An explanation will be given below regarding a preferred embodiment of the present invention while referring to the attached drawings. FIG. 1 is a block diagram showing an electrical configuration of the electronic instrument 1, according to one preferred embodiment of the present invention.

The electronic instrument 1 comprises a CPU 2, a ROM 3, a RAM 4, a keyboard 5, an operating panel 6, a set of pedals 7, and a sound source 8. These elements of the electronic instrument may be mutually interconnected by means of a bus line. An output of the sound source 8 is connected to a D/A converter 9. An output of the D/A converter 9 is connected to an amplifier 10, a first headphone circuit 12, and a second headphone circuit 13. The amplifier 10 is connected to a speaker 11.

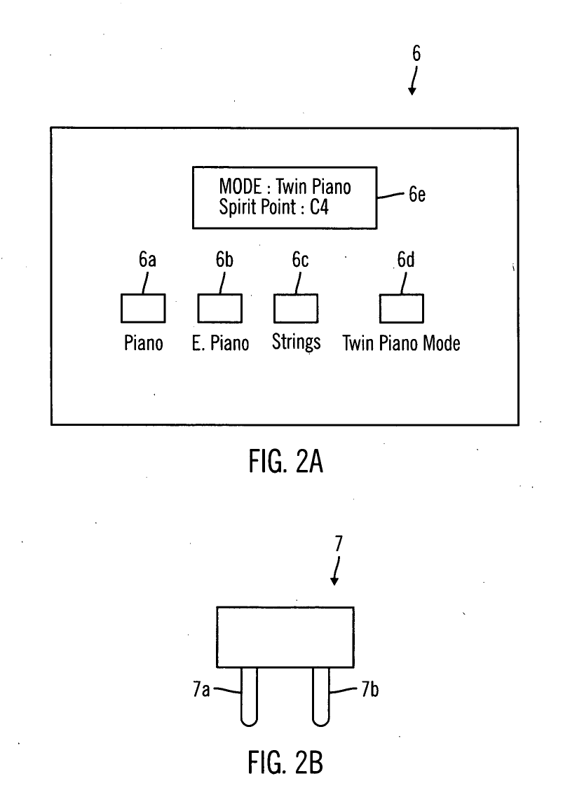

The CPU 2 comprises an arithmetic processing unit. Various types of control programs that are executed by the CPU 2, as well as fixed value data that are referred to when the control programs are executed, may be stored in the ROM 3. A shift table and a velocity table, each of which will be discussed later, may be included as fixed value data. The RAM 4 comprises rewritable memory. The rewritable memory may be used for temporary storage of a Mode Flag that indicates a mode status, a Mode Button Flag that indicates whether a mode switch 6d (see FIG. 2a) is pressed, and a Mode Change Flag that indicates whether a mode change is in execution. The RAM 4 may also store various types of data and the like used for the execution of the control programs that are stored in the ROM 3 and the like.

The keyboard 5 has a plurality of white keys and black keys. The keys of the keyboard 5 range from a lowest key to a highest key. The keyboard 5 outputs pitches, key pressing speeds, and key releasing speeds in accordance with pressing and releasing of keys by a user.

The operating panel 6, may be positioned in the vicinity of the keyboard 5 and may have various types of knobs and switches. An operating mode, parameters of musical tones, and the like may be manually set by the user. The pedals 7 may be placed below the keyboard 5 and at a foot level of the user for operation by the user using his or her foot.

The sound source 8 outputs a digital musical tone signal that is converted into an analog musical tone signal by the D/A converter 9. The analog musical tone signal that has been converted by the D/A converter 9 is supplied to the amplifier 10 and to the first headphone circuit 12 and the second headphone circuit 13. In cases where headphones are not connected to connection terminals of the first and the second headphone circuits 12 and 13, the analog musical tone signal is emitted from the speaker 11. In those cases where headphones are connected to the connection terminal of either of the first and the second headphone circuits 12 and 13, the analog musical tone signal is not emitted from the speaker 11 and is instead emitted from the headphone that has been connected. Alternatively, the system may be configured to allow production of audio signals from both the speaker 11 and one or more of the headphone circuits 12 and 13, such that one person may listen to tone signals through a headphone connected to at least one of the first and second headphone circuits 12 and 13, while another person may listen to tone signals through the speaker 11.

Next, an explanation will be given regarding the operating panel 6 and the pedals 7 of the electronic instrument 1 in reference to FIGS. 2a and 2b. FIG. 2a shows a preferred embodiment of the operating panel 6 of the electronic instrument 1. The operating panel 6 is furnished with timbre selection switches 6a, 6b and 6c. The operating panel 6 is also furnished with the mode switch 6d. The mode switch 6d facilitates selecting between (1) a normal mode in which the keys of the keyboard 5 constitute a single keyboard zone and (2) a divided mode (the twin piano mode) in which the keys of the keyboard 5 are divided into two keyboard zones. The operating panel 6 is also furnished with a display device 6e that displays the mode that has been selected and the like.

The timbre selection switch 6a, the timbre selection switch 6b, and the timbre selection switch 6c are switches that respectively select timbres of a piano, those of an electronic piano, and those of strings. The mode switch 6d, in addition to facilitating switching between the normal mode and the divided mode, may be used to set a split point (a dividing position) at which the keyboard 5 is divided into the two keyboard zones, an upper keyboard zone and a lower keyboard zone. To explain in detail, in those cases where the electronic instrument 1 is operating in the normal mode and the mode switch 6d is then operated, the divided mode is selected and the electronic instrument 1 is then selected to operate in the divided mode. In those cases where the electronic instrument 1 is operating in the divided mode and the mode switch 6d is then operated, the normal mode is selected and the electronic instrument 1 is then selected to operate in the normal mode. The Mode Flag that is stored in the RAM 4 may carry a value of 0 when the electronic instrument 1 is operating in the normal mode. The Mode Flag may carry a value of 1 when the electronic instrument 1 is operating in the divided mode.

In those cases where the electronic instrument 1 is operating in either the normal mode or the divided mode, when any key of the keyboard 5 is pressed down while the mode switch 6d is also operated, the key that is pressed down is selected as the split point. In conjunction, the instrument 1 is then selected to operate in the divided mode. The split point may mark the lowest key of the upper keyboard zone. For example, when a key corresponding to C4 is pressed down while the mode switch 6d is operated, the key corresponding to C4 is set as the split point. Accordingly, the lower keyboard zone will range from the lowest key of the keyboard 5 through a key corresponding to B4. Also, the upper keyboard zone will range from the key corresponding to C4 through the highest key of the keyboard 5. The display device 6e may be configured using an LCD and the like. The display device 6e may display the mode that has been selected and the split point.

FIG. 2b shows the pedals 7 in an embodiment of the electronic instrument 1. The pedals 7 may be depressed by a foot of the user. The pedals 7 include the first pedal 7a and the second pedal 7b. The pedals 7a and 7b may each be furnished with variable resistors, and a voltage that corresponds to a position to which the pedal is depressed may be detected by an A/D converter (not shown). In those cases where the electronic instrument 1 is selected to operate in the normal mode, the first pedal 7a functions as a soft pedal, and the second pedal 7b functions as a damper pedal.

On the other hand, in those cases where the electronic instrument 1 is selected to operate in the divided mode, the first pedal 7a functions as a damper pedal serving the lower keyboard zone, and the second pedal 7b functions as a damper pedal serving the upper keyboard zone.

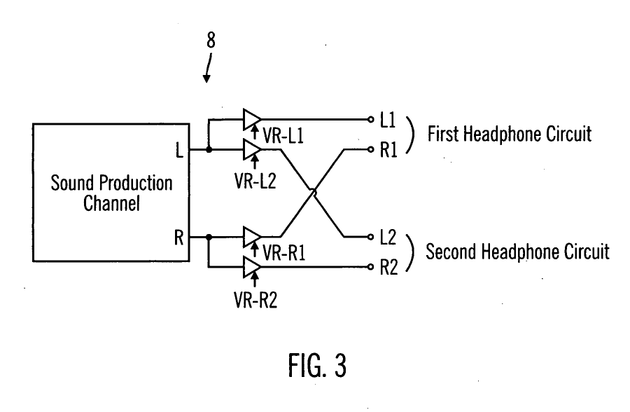

Next, an explanation will be given in reference to FIG. 3 regarding sound production channels of the sound source 8. FIG. 3. shows a configuration of one of the sound production channels in an embodiment of the musical instrument 1. The sound source 8 comprises a digital circuit, and the sound source 8 can produce a plurality (for example, 64) of musical tones at the same time. The configuration that forms each individual musical tone is referred to as a sound production channel. The sound source 8 may include an arithmetic circuit for carrying out various processes, and the sound source 8 may produce musical tones corresponding to a plurality of sound production channels by using the arithmetic circuit and time division.

In FIG. 3, for ease of explanation, one sound production channel is shown as a single box. The sound production channel has a left channel output L and a right channel output R. The left channel output L is fed to a left channel L1 of the first headphone circuit 12 through a multiplier using VR-L1 as a multiplicative coefficient and to a left channel L2 of the second headphone circuit 13 through a multiplier using VR-L2 as a multiplicative coefficient. The right channel output R is fed to a right channel R1 of the first headphone circuit 12 through a multiplier using VR-R1 as a multiplicative coefficient and to a right channel R2 of the second headphone circuit 13 through a multiplier using VR-R2 as a multiplicative coefficient. Values of the multiplicative coefficients VR-L1, VR-L2, VR-R1, and VR-R2 may vary from 0 to 1. In those cases where the value of one of the multiplicative coefficients is set to 0, a 0% level of the corresponding channel output is fed to the corresponding channel of the corresponding headphone circuit. In those cases where the value of one of the multiplicative coefficients is set to 1, a 100% level of the corresponding channel output is fed to the corresponding channel of the corresponding headphone circuit.

The outputs L1, L2, R1, and R2 that have been multiplied by the multiplicative coefficients VR-L1, VR-L2, VR-R1, and VR-R2 are respectively combined with respective outputs of other sound production channels. In this manner, the outputs from the multiple sound production channels are summed for output to the headphones or speaker. In particular, the summed combination of the respective L1 outputs and the summed combination of the respective R1 outputs are output to the first headphone circuit 12. The summed combination of the respective outputs L2 and the summed combination of the respective outputs R2 are output to the second headphone circuit 13.

In those cases where the electronic instrument 1 has been selected to operate in the normal mode, the values of the multiplicative coefficients VR-L1, VR-L2, VR-R1, and VR-R2 are all set to 1. In those cases where the electronic instrument 1 has been set to operate in the divided mode, the values of the multiplicative coefficients are changed depending on the keyboard zone to which a key corresponding to a given sound production channel belongs.

As an example, in those cases where the given sound production channel corresponds to a key in the upper keyboard zone, the values of VR-L1 and VR-R1 may be set to 1, and the values of VR-L2 and VR-R2 may be set to 0. Accordingly, in those cases where the given sound production channel corresponds to a key in the upper keyboard zone, a musical tone generated by the given sound production channel may be, in effect, output to the first headphone circuit 12 and may be, in effect, not output to the second headphone circuit 13.

As another example, in those cases where the given sound production channel corresponds to a key in the lower keyboard zone, the values of VR-L1 and VR-R1 may be set to 0, and the values of VR-L2 and VR-R2 may be set to 1. Accordingly, in those cases where the given sound production channel corresponds to a key in the lower keyboard zone, a musical tone generated by the given sound production channel may be, in effect, output to the second headphone circuit 13 and may be, in effect, not output to the first headphone circuit 12.

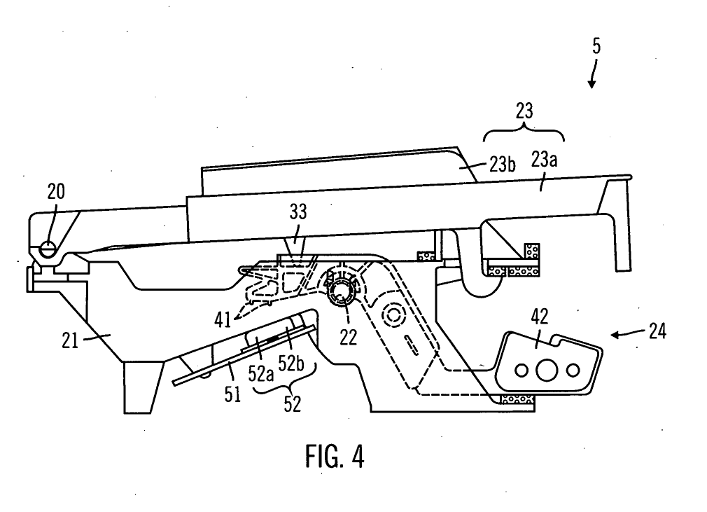

Next, an explanation will be given regarding the keyboard 5 in an embodiment of the electronic instrument 1. FIG. 4 is a lateral drawing of the keyboard 5. The keyboard 5 may be furnished primarily with a chassis 21 that is formed using a resin. The keyboard 5 may also be furnished with a plurality (for example, 88) of keys 23 that comprise the white keys 23a and the black keys 23b. Each of the keys may be supported so that it is free to pivot along a shaft 20 disposed on the chassis 21. The keyboard 5 may also be furnished with a hammer 24 that is arranged on each of the keys 23 and that swings upon the pressing or the releasing of the corresponding key. The hammer 24 pivots along a shaft bearing 22 disposed on the chassis 21 and shaped like the letter “U” when viewed in cross-section. The hammer 24 pivots upon movement of a protrusion 33 of the key against one end of the hammer 24. Another end of the hammer 24 has been furnished with a mass plate 42. The mass plate 42 adds mass to the key in order to impart a touch similar to that of a key of an acoustic piano. The mass plate of a first hammer may have a mass different from a mass of a mass plate of a second hammer. For example, the mass of a mass plate disposed on a hammer corresponding to a first key may be greater than the mass of a mass plate disposed on a hammer corresponding to a second key that is higher than the first key.

A switch pressure section 41 may be used for contacting a switch 52 in order to detect a key pressing speed. The switch pressure section 41 may be formed on a side of the hammer 24 opposite to the side of the hammer 24 on which the mass plate 42 is disposed. The switch 52 may be disposed on a printed circuit board and may include two contact points 52a and 52b. The contact points are arranged so as to be contacted at different times by the switch pressure section 41 as the key 23 is pressed down. Accordingly, the key pressing speed is detected by measuring a difference between the times at which the two contact points were contacted (key pressing time).

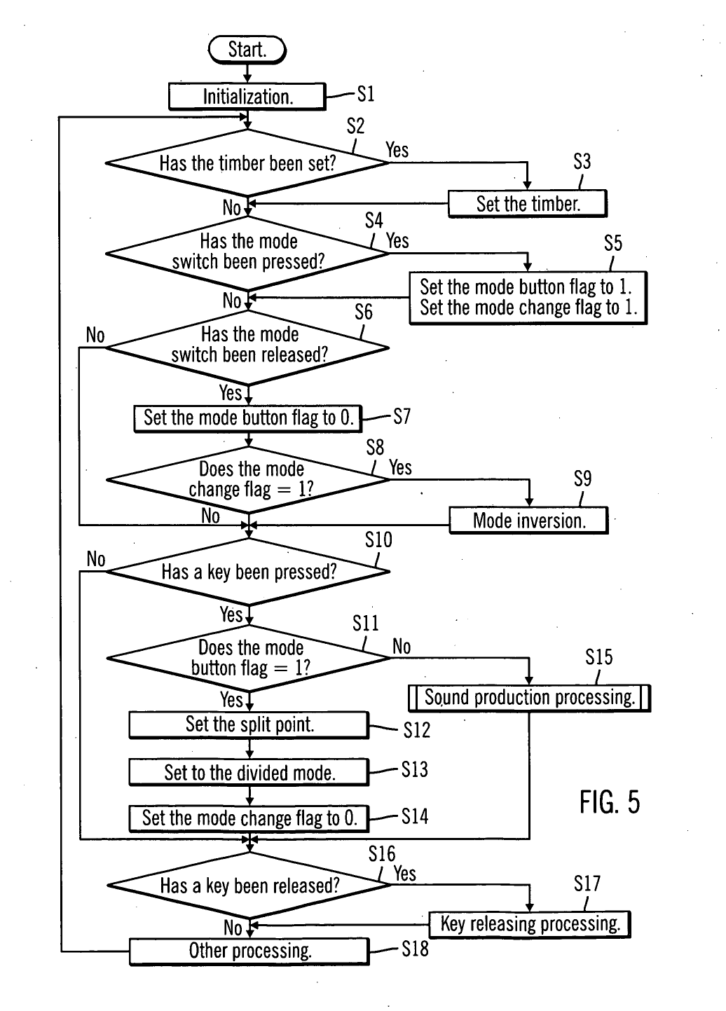

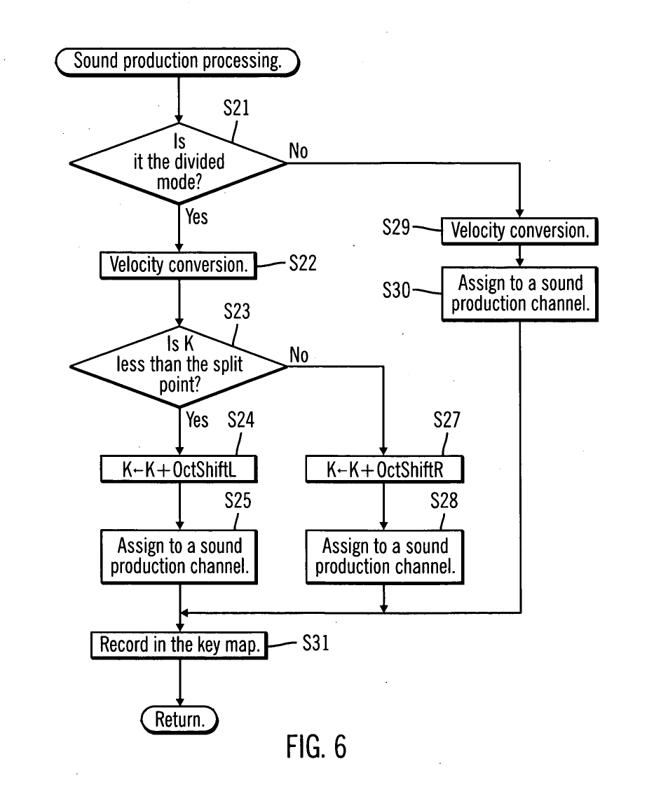

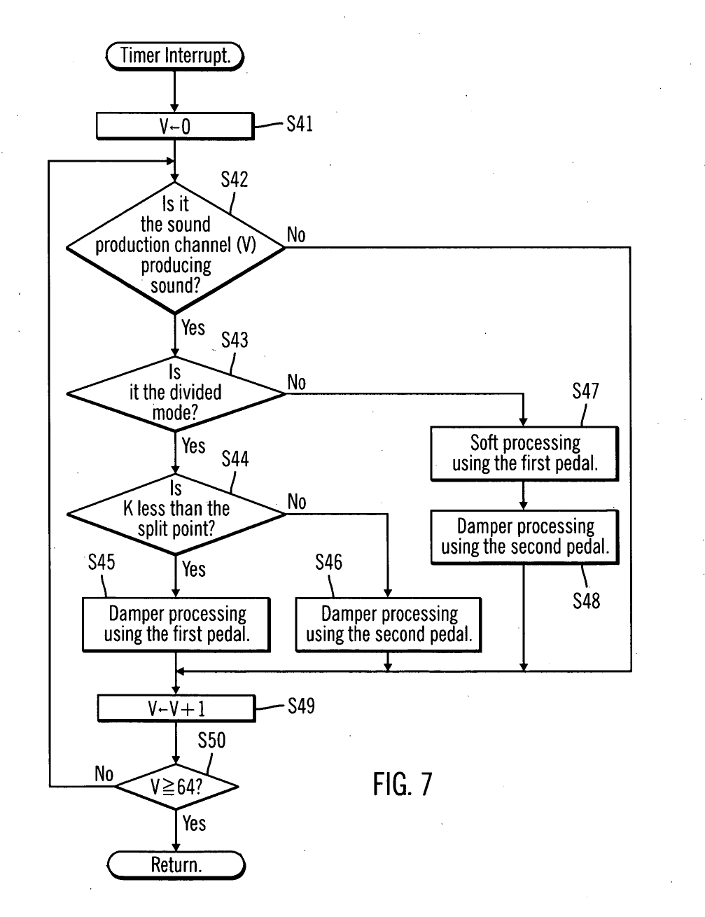

Next, an explanation will be given in reference to FIG. 5, FIG. 6 and FIG. 7, regarding processing that may be executed by the CPU 2 in a preferred embodiment of the electronic instrument 1.

FIG. 5 is a flowchart that shows main processing that may be executed by the CPU 2. The main processing may be executed continuously from a time that power to the electronic instrument 1 is applied until the power to the electronic instrument 1 is turned off. First, initialization in S1 is carried out. By default, the Mode Flag is set to 0 (normal mode), the Mode Button Flag and the Mode Change Flag are each set to 0, and processing such as that involving a timer interrupt, which is used in conjunction with operation of the pedals 7, and the like is carried out.

Next, a determination in S2 is made as to whether or not any of the timbre selection switches 6a, 6b, or 6c has been operated. In those cases where a determination has been made that any of the timbre selection switches has been operated (S2: yes), timbre setting processing in S3 is carried out such that waveforms corresponding to the selected timbre are read out. It is assumed here that only one timbre can be operative at any given time.

In those cases where a determination has been made that a timbre selection switch has not been operated (S2: no) or in those cases where the timbre selection processing in S3 is completed, a determination in S4 is next made as to whether or not the mode switch 6d has been pressed. The mode switch 6d may be determined to have been pressed when the mode switch 6d is changed from a released state to a pressed state. In those cases where a determination has been made that the mode switch 6d has been pressed (S4: yes), the Mode Button Flag is set to 1 and the Mode Change Flag is set to 1 in accordance with S5.

In those cases where a determination has been made that the mode switch 6d has not been pressed (S4: no) or in those cases where the Mode Button Flag and the Mode Change Flag have been set in accordance with S5, a determination in S6 is made as to whether or not the mode switch 6d has been released. For example, the mode switch 6d may be determined to have been released when the mode switch 6d is changed from a pressed state to a released state.

In those cases where a determination has been made that the mode switch 6d has been released (S6: yes), the Mode Button Flag is set to 0 in accordance with S7, a determination in S8 is made as to whether or not the Mode Change Flag is set to 1. In those cases where a determination has been made that the Mode Change Flag is set to 1 (S8: yes), the operating mode is inverted in accordance with S9. For example, in those cases where the Mode Flag is currently set to 0 (the normal mode), the Mode Flag is inverted to be set to 1 (the divided mode). Likewise, in those cases where the Mode Flag is currently set to 1 (the divided mode), the Mode Flag is inverted to be set to 0 (the normal mode).

In those cases where a determination has not been made in S6 that the mode switch 6d has been released (S6: no), in those cases where a determination has not been made in block S8 that the Mode Change Flag is set to 1 (S8: no), and in those cases where the operating mode is inverted in accordance with S9, a determination is next made in S10 as to whether or not any key of the keyboard 5 has been pressed down.

In those cases where a determination has been made that a key of the keyboard 5 has been pressed down (S10: yes), a determination in S11 is made as to whether or not the Mode Change Flag is set to 1. In those cases where a determination has been made that the Mode Change Flag is set to 1 (S11: yes), a pitch corresponding to the key is stored in the RAM 4 as the split point. In S12, the split point is displayed on the display device 6e. Next, in S13, the Mode Flag is set to 1 to indicate that the musical instrument 1 has been selected to operate in the divided mode. In S14, the Mode Change Flag is set to 0. By means of processing in S13, the operating mode may be set to the divided mode once the split point has been stored, irrespective of whether the then-current operating mode was the normal mode or the divided mode.

In those cases where a determination has been made by the processing in S11 that the Mode Button Flag is not set to 1 (S11: no), sound production processing that will be discussed later is carried out in S15.

In those cases where a determination has been made by the processing in S10 that a key has not been pressed down, in those cases where the processing of S14 has set the Mode Change Flag to 0, and in those cases where the sound production processing of S15 is completed, a determination in S16 is next made as to whether or not any of the keys of the keyboard 5 has been released. In those cases where any of the keys has been released (S16: yes), key releasing processing in S17 may be performed. The key releasing processing may stop generation of musical tones generated in conformance with any of the keys that were pressed down and have been released. A key map stored in the RAM 4 may be used for storing correspondences between sound production channels and keys. The key releasing processing of S17 may use the key map to identify a sound production channel corresponding to each of the released keys and then instruct the corresponding sound production channel(s) to stop the generation of the musical tone(s).

In those cases where a determination has been made in the processing of S16 that none of the keys has been released (S16: no) and in those cases where the key releasing processing of S17 is completed, other processing is carried out in S18, and the main processing returns to the processing of S2. In the other processing of S18, detection of whether or not a knob for adjusting volume (not shown in the drawing) may be performed and, in those cases where the knob has been operated, processing to control the volume and the like may be carried out.

Next, an explanation will be given regarding the sound production processing in SI5 in reference to FIG. 6. As shown in FIG. 6, a determination is first made in block S21 as to whether the Mode Flag is set to 1. In those cases where the Mode Flag is set to 1 (S21: yes), in block S22, a velocity curve stored in the ROM 3 may be referred to, and a velocity value may be obtained in conformance with a pitch K of the key that has been pressed.

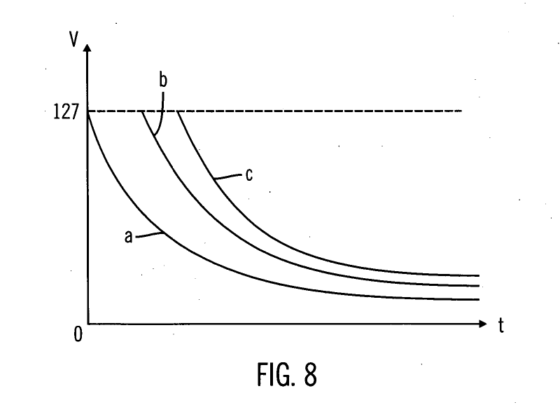

FIG. 8 shows graphical examples of velocity curves that may be stored in the ROM 3. In FIG. 8, the values of the difference between the times that the contact points 52a and 52b may be contacted are represented along the horizontal axis, and velocity values (which are stipulated in accordance with MIDI standards and may take values ranging from 0 to 127) are represented along the vertical axis. The curve labeled ‘a’ that is shown in FIG. 8 is a curve that may be applicable to keys of the entire keyboard zone in the normal mode. The curve ‘a’ may also be applicable to keys of an upper keyboard zone in the divided mode. The curves labeled ‘b’ and ‘c’ that are shown in FIG. 8 are curves that may be applicable in the divided mode. The curve ‘b’ is a curve that may be applicable to keys of a first lower keyboard zone, and the curve ‘c’ is a curve that may be applicable to keys of a second lower keyboard zone, the highest key of which is lower than the highest key of the first lower keyboard zone. The curves ‘b’ and ‘c’ may be used to obtain a velocity value greater than that which would have been obtained using the curve ‘a’ assuming a given key pressing time.

The keys of the keyboard 5 are formed so as to resemble those of an acoustic piano by weighing to a greater degree keys lower than other keys. Accordingly, so that a volume level produced by two musical tones may be equivalent in those cases where the keyboard is divided into two keyboard zones and each musical tone corresponds to a different keyboard zone, the force that is required to press down the corresponding key is greater in the lower keyboard zone than in the upper keyboard zone. Therefore, in cases where the mode has been set to the divided mode, velocity values may be set appropriately so that the velocity values may be adjusted to compensate for the greater degree of required force.

For example, in those cases where a keyboard zone ranges from A0 to B2, the curve ‘c’ may be used. In those cases where a keyboard zone ranges from C3 to B3, the curve ‘b’ may be used. In those cases where a keyboard zone ranges from C4 on the lowest end, the curve ‘a’ may be used. The key pressing times are then converted into velocity values.

With these curves, it may be set up such that the touch in the case where the divided mode has been selected becomes apparently the same no matter which key has been pressed down, and it may also be set to a curve in which the touch becomes the same in the divided mode as that of the pitch in the normal mode, and such that the touch that corresponds to the pitch in the divided mode becomes equal to the touch that corresponds to the pitch in the normal mode based on the pitches in the normal mode and the pitches in the divided mode.

Next, a determination is made in S23 as to whether or not a pitch K of a key that has been pressed is lower than the split point that is stored in the RAM 4. The pitch K and the split point are represented by note numbers according to which a half-note separation is denoted by a value of 1 in accordance with MIDI standards.

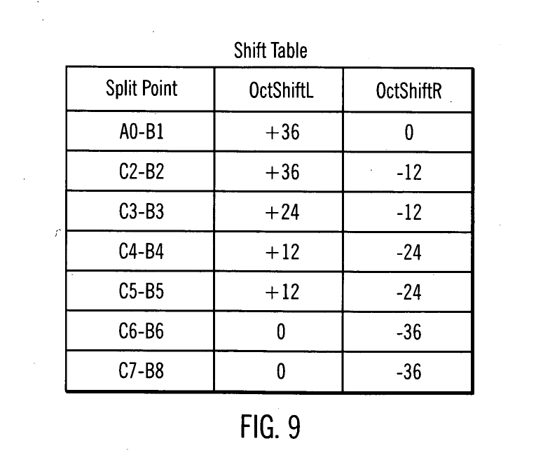

In those cases where the pitch K is lower (the note number is lower) than the split point (S23: yes), the key that has been pressed down is determined to belong to the lower keyboard zone. The shift table stored in the ROM 3 is referred to, and a corresponding value of OctShiftL is added to the pitch K in S24. FIG. 9 shows an embodiment of the shift table that is stored in the ROM 3. The shift table stores values of the OctShiftL, which is the shift value that is added to the note numbers of keys in the lower keyboard zone in conformance with a given split point, and of the OctShiftR, which is a shift value that is added to the note numbers of keys in the upper keyboard zone. For example, in those cases where the split point is set to C4, if a note number of the key that has been pressed equals N and the note number is determined to belong to the lower keyboard zone, the note number N is converted to a value of N+12. As another example, if the note number N is determined to belong to the upper keyboard zone, the note number N is converted to a value of N-24.

In S25, the converted note number and a velocity value corresponding to the key that has been pressed are allocated to a unused sound production channel of the sound source 8, and the coefficients VR-L1 and VR-R1 of the sound production channel may be set to 0, and the coefficients VR-L2 and VR-R2 may be set to 1 such that a musical tone produced by the sound production channel is output to the second headphone circuit 13.

In those cases where S23 determines that the pitch K is not lower (the note number is not lower) than the split point (S23: no), the key that has been pressed is determined to belong to the upper keyboard zone. The shift table that has been stored in the ROM 3 is referred to, and a corresponding value of OctShiftR is added to the pitch K in reference to S27. In S28, the converted note number and the velocity value corresponding to the key that has been pressed are allocated to a unused sound production channel of the sound source 8, and the coefficients VR-L1 and VR-R1 of the sound production channel may be set to 1, and the coefficients VR-L2 and VR-R2 may be set to 0 such that a musical tone formed by the sound production channel is output to the first headphone circuit 12.

In those cases where a determination has been made in S21 that the Mode Flag has not been set to 1 (S21: no), in S29, a velocity curve stored in the ROM 3 is referred to, the key pressing time is converted into a velocity value. In S30, the note number corresponding to the key that has been pressed down and the velocity value are allocated to a unused sound production channel of the sound source 8 (S30).

When the allocation to the sound production channel in the processing of S25, S28, or S30 is completed, the sound production channel to which the key that is pressed has been allocated is recorded in the key map that is stored in the RAM 4, the sound production processing is completed, and the routine returns to the main processing.

Next, an explanation will be given regarding pedal operation processing while referring to FIG. 7. FIG. 7 is a flowchart that shows the pedal operation processing that may be launched by a timer interrupt having an interval of a specified time (for example, 10 msec). First, in S41, a variable V for carrying out the pedal operation processing for each sound production channel is made initialized to zero. In an embodiment of the present invention, the total number of sound production channels equals 64, and the variable V then spans integer values ranging from 0 to 63. Next, in S42, a determination is made as to whether or not a V-th sound production channel is in the midst of sound production. A flag that indicates whether or not sound is being produced is stored in the RAM 4 for each sound production channel. The flag is set when the pitch in which the sound production starts has been allocated to the V-th sound production channel by the CPU 2 and is reset in those cases where the sound production has stopped due to key releasing.

In those cases where the V-th sound production channel is producing sound (S42: yes), a determination is made in S43 as to whether or not the Mode Flag is set to 1 (the divided mode). In those cases where the Mode Flag is 1 (S43: yes), a determination is made in S44 as to whether or not the pitch K that has been allocated to the V-th sound production channel is lower than the split point. In those cases where the pitch K is lower than the split point (S44: yes), damper processing in S45 is carried out in conformance with an operating state of the first pedal 7a, In those cases where the pitch K is not lower than the split point (S44: no), damper processing in S46 is carried out in conformance with an operating state of the second pedal 7b. The damper processing is processing that rapidly attenuates the amplitude of the musical tone in those cases where the key has been released and the pedal is in a non-operated state (not being stepped on). On the other hand, the damper processing maintains or slowly attenuates the amplitude of the musical tone in those cases where the key has been released and the pedal is in an operated state (being stepped on).

On the other hand, in those cases where a determination has been made in the processing of S43 that the Mode Flag is not set to 1 and that the electronic instrument is operating in the normal mode (S43: no), in S47, soft processing is carried out in conformance with the operating state of the first pedal 7a, and, in S48, the damper processing is carried out in conformance with the operating state of the second pedal 7b. The soft processing is processing for providing normal volume in those cases where the pedal is not being operated, and for providing a volume equivalent to one-half of the normal volume in those cases where the pedal is being operated.

In those cases either where a determination has been made in the processing of S42 that the sound production channel (V) is not producing sound or following the processing of S45, S46, or S48, the variable V is incremented by 1 in S49. Then, in S50, a determination is made as to whether or not the value of V is equal to or greater than 64. In those cases where the value of the variable V is less than 64 (S50: no), the routine returns to the processing of S42, and in those cases where the variable V is equal to or greater than 64 (S50: yes), the interrupt processing ends and the routine returns to the main processing.

As has been explained above, in accordance with the electronic instrument 1 of a preferred embodiment, a musical tone that has been generated by the sound source 8 can be output to two headphones. In the normal mode in which the keyboard is used as a single keyboard zone, the musical tone may be supplied to the two headphones. In the divided mode in which the keyboard is divided into two keyboard zones, musical tones generated from each keyboard zone are respectively supplied to the corresponding headphone. Accordingly, in those cases where a single keyboard is divided and a performance is carried out independently in each keyboard zone, since a user performing in one keyboard zone will not hear musical tones created by another user performing in another keyboard zone, it is possible to suitably carry out a performance in each of the keyboard zones without interference.

In addition, in those cases where the touch of the keys of the keyboard is different depending on the pitch, since when the keyboard is divided into a plurality of keyboard zones and a performance is carried out in each of the keyboard zones, a conversion is done such that the velocity value becomes large for a keyboard zone in which the touch is heavy, it is possible for the performance to be made such that there is no difference with the case in which the performance is in another keyboard zone.

The processing of S22 of the flowchart shown in FIG. 6 may provide velocity value setting means in embodiments of the present invention. The processing of S25 and of S28 may provide transmitting means in embodiments of the present invention.

In addition, the processing of S24 and of S27 of the flowchart shown in FIG. 6 may provide register setting means in embodiments of the present invention. In addition, the processing of S12 of the flowchart shown in FIG. 5 may provide dividing position setting means in embodiments of the present invention. In addition, the processing of S24 and of S27 of the flowchart shown in FIG. 6 may provide pitch allocation changing means in embodiments of the present invention. The processing of S25 and of S28 may provide transmitting means in embodiments of the present invention.

An explanation was given above of the present invention based on preferred embodiments. However, the present invention is in no way limited to the preferred embodiments described above. That various modifications and changes, which do not deviate from and are within the scope of the essentials of the present invention, can be easily surmised.

For example, in the preferred embodiments, the electronic instrument 1 has been set up such that the keyboard 5 is built in, but the keyboard 5 may comprise a separate unit, and it may be set up such that performance data are transmitted from the keyboard 5 to the electronic instrument 1 using a communications format that complies with MIDI standards.

In addition, in the preferred embodiments, the configuration is such that the electronic instrument 1 has two headphones and each of the two people who carries out the performance uses separate headphones in listening to the musical tones that he or she has performed. However, it may also be set up such that one person uses the headphones and listens to his or her performance while the other person listens to his or her performance from the speaker.

In addition, in preferred embodiments described above, in those cases where a sound producing channel has been allocated to a key that belongs to an upper keyboard zone, VR-L1 and VR-R1 have been set to 1, and VR-L2 and VR-R2 have been set to 0. However, it may also be set up such that VR-L2 and VR-R2 are set to a value such as, for example, 0.3, allowing a user who carries out a performance in a lower keyboard zone to listen to tones generated from the upper keyboard zone at a low volume while also listening to tones generated from the lower keyboard zone at a higher volume. For example, in those cases where a teacher or a parent carries out a performance practice in the lower keyboard zone and a child carries out a performance in the upper keyboard zone, the teacher or parent can listen to the child's playing at the same time as his or her own playing and thereby carry out coaching appropriately.

In addition, in preferred embodiments described above, it has been set up such that the physical touch of the keys is not changed in spite of the mode, an apparent touch is changed by means of the change in the velocity value in conformance with the key pressing speed. In a further embodiment, it may also be set up such that the touch of the key is changed physically. For example, a magnet may be disposed adjacent to the hammer of each key, and the hammer may be formed from a ferromagnetic body. Thus, it would be possible to vary the distance between the magnet and the hammer while the hammer is at rest, and, correspondingly, the hammer would be made easier or more difficult to pivot.

In addition, in preferred embodiments described above, the pitches that are allocated to the keys are changed in selecting the divided mode. However, in a further embodiment, the pitches that are allocated to the keys may be changed by means of a so-called transpose capability.

In addition, in the preferred embodiment described above, it has been set up such that the shift table that is shown in FIG. 9 is referred to and the pitch is shifted in those cases where a split point has been set, but it may be also set up such that a relationship is set between the split point and a key having a specific pitch notation. For example, when the split point is set, the key for the highest C of the lower key zone is set to C5 and key for the lowest C of the upper key zone is set to C3. By means of this kind of setting, in those cases where the split point is changed the octave relationships of the key zone—in other words, the position of the middle C (C4)—becomes easy to find.

In the same manner, in those cases where the key zone has been divided, it may be set up such that for the lower key zone, the lowest C is made C3 and for the upper key zone, the highest C is set to C5 without regard to the location of the split point.

What is claimed is:

1. An electronic instrument comprising:
a plurality of keys;
mode selection means for selecting one mode of a normal mode and a divided mode, wherein, upon selecting of the normal mode, musical tones having a first set of characteristics are assigned to a single keyboard zone spanning the plurality of keys, and wherein, upon selecting of the divided mode, the single keyboard zone is divided into a plurality of keyboard zones, and musical tones having a second set of characteristics different from the first set of characteristics are assigned to each of the plurality of keyboard zones;
musical tone generation means for generating a musical tone upon operation of one key of the plurality of keys, wherein the musical tone is generated in conformance with the one mode selected by the mode selection means;
first output means for outputting the musical tone generated by the musical tone generation means to a first headphone;
second output means for outputting the musical tone generated by the musical tone generation means to a sound emitting means different from the first output means; and
feed means for feeding the musical tone generated by the musical tone generation means from the musical tone generation means to at least one of the first output means and the second output means;
wherein, upon the selecting of the normal mode by the mode selection means, the musical tone generated by the musical tone generation means is fed to the at least one of the first output means and the second output means; and
wherein, upon the selecting of the divided mode by the mode selection means, the musical tone generated by the musical tone generation means is fed to the first output means if the one key of the plurality of keys is in a first keyboard zone of the plurality of keyboard zones and is fed to the second output means if the one key of the plurality of keys is in a second keyboard zone of the plurality of keyboard zones.

2. The electronic instrument according to claim 1,
wherein the second output means outputs the musical tone generated by the musical tone generation means to a second headphone; and
wherein the feed means, upon the selecting of the normal mode by the mode selection means, feeds the musical tone generated by the musical tone generation means to the first output means and the second output means.

3. The electronic instrument according to claim 1,
wherein the feed means, upon the selecting of the divided mode by the mode selection means, combines (1) a first musical tone that has been played using the first keyboard zone and having a first volume level and (2) a second musical tone that has been played using the second keyboard zone and having a second volume level and feeds the combined musical tones to at least one of the first and the second output means; and
wherein the second volume level is lower than the first volume level.

4. An electronic instrument comprising:
a plurality of keys, wherein a key pressing force required to press down a first key is greater than a key pressing force required to press down a second key, the first key having a lower pitch than the second key;
mode selection means for selecting one mode of a normal mode and a divided mode,
wherein, upon selecting of the normal mode, musical tones having a first set of characteristics are assigned to a single keyboard zone spanning the plurality of keys, and wherein, upon selecting of the divided mode, the single keyboard zone is divided into a plurality of keyboard zones, and musical tones having a second set of characteristics different from the first set of characteristics are assigned to each of the plurality of keyboard zones;
musical tone generation means for generating a musical tone upon operation of one key of the plurality of keys, wherein the musical tone is generated in conformance with the one mode selected by the mode selection means;
key pressing speed detection means for detecting a pressing speed of the one key of the plurality of keys;
velocity value setting means for setting a velocity value in conformance with the pressing speed detected by the key pressing speed detection means, wherein, upon selecting of the divided mode by the mode selection means the velocity value is set to a first value, wherein, upon selecting of the normal mode by the model selection means the velocity value is set to a second value, and wherein, if the one key is in a lower of the plurality of keyboard zones the first value is greater than the second value; and
transmitting means for transmitting the velocity value set by the velocity value setting means to the musical tone generation means.

5. The electronic instrument according to claim 4 further comprising:
register setting means for, upon selecting of the divided mode by the mode selection means, assigning at least one register to at least one of the plurality of keyboard zones, the at least one register different from a register assigned by the register setting means upon selecting of the normal mode by the mode selection means.

6. The electronic instrument according to claim 5, further comprising:
dividing position setting means for setting ad libitum dividing positions at which the single keyboard zone is divided into the plurality of keyboard zones,
wherein the register setting means assigns the at least one register in conformance with the dividing positions set by the dividing position setting means.

7. The electronic instrument according to claim 4,
wherein the velocity value setting means converts the pressing speed to the velocity value in conformance with the operation of the one key of the plurality of keys and a pitch of the musical tone generated by the musical tone generation means.

8. The electronic instrument according to claim 4, further comprising:
first output means for outputting the musical tone generated by the musical tone generation means to a first headphone;
second output means for outputting the musical tone generated by the musical tone generation means to a sound emitting means different from the first output means; and
feed means for feeding the musical tone generated by the musical tone generation means from the musical tone generation means to at least one of the first output means and the second output means;
wherein, upon the selecting of the normal mode by the mode selection means, the musical tone generated by the musical tone generation means is fed to the at least one of the first output means and the second output means, and
wherein, upon the selecting of the divided mode by the mode selection means, the musical tone generated by the musical tone generation means is fed to the first output means if the one key of the plurality of keys is in a first keyboard zone of the plurality of keyboard zones and is fed to the second output means if the one key of the plurality of keys is in a second keyboard zone of the plurality of keyboard zones.

9. The electronic instrument according to claim 8,
wherein the second output means outputs the musical tone generated by the musical tone generation means to a second headphone; and
wherein the feed means, upon the selecting of the normal mode by the mode selection means, feeds the musical tone generated by the musical tone generation means to the first output means and the second output means.

10. The electronic instrument according to claim 8,
wherein the feed means, upon the selecting of the divided mode by the mode selection means, combines (1) a first musical tone that has been played using the first keyboard zone and having a first volume level and (2) a second musical tone that has been played using the second keyboard zone and having a second volume level and feeds the combined musical tones to at least one of the first and the second output means; and
wherein the second volume level is lower than the first volume level.

11. An electronic instrument comprising:
a plurality of keys, wherein a key pressing force required to press down a first key is greater than a key pressing force required to press down a second key, the first key having a lower pitch than the second key;
key pressing speed detection means for detecting a pressing speed of an operated key of the plurality of keys;
pitch detection means for detecting a pitch assigned to the operated key;
musical tone generation means for generating a musical tone based on the pressing speed detected by the key pressing speed detection means and the pitch detected by the pitch detection means;
pitch assignment changing means for changing the pitch detected by the pitch detection means;
velocity value setting means for setting a velocity value based on the pressing speed detected by the key pressing speed detection means and based on the pitch detected by the pitch detection means and the pitch changed by the pitch assignment changing means; and
transmitting means for transmitting the pitch changed by the pitch assignment changing means and the velocity value set by the velocity value setting means to the musical tone generation means.

12. An electronic instrument comprising:
a plurality of keys;
mode selection means for selecting one mode of a normal mode and a divided mode, wherein, upon selecting of the normal mode, musical tones having a first set of characteristics are assigned to a single keyboard zone spanning the plurality of keys, and wherein, upon selecting of the divided mode, the single keyboard zone is divided into a plurality of keyboard zones, and musical tones having a second set of characteristics different from the first set of characteristics are assigned to each of the plurality of keyboard zones;
musical tone generation means for generating a musical tone upon operation of one key of the plurality of keys, wherein the musical tone is generated in conformance with the one mode selected by the mode selection means;
dividing position setting means for, upon selecting of the divided mode by the mode selection means, setting ad libitum dividing positions at which the single keyboard zone is divided into the plurality of keyboard zones; and
register setting means for assigning registers to each of the plurality of keyboard zones in conformance with the dividing positions set by the dividing position setting means.

13. An electronic instrument comprising:
a first and a second key;
a first and a second sound production channel each having a first and a second output;
a first, a second, a third, and a fourth multiplier;
a first and a second combiner; and
a first and a second audio outlet;
wherein the first sound production channel is assigned to the first key;
wherein the second sound production channel is assigned to the second key;
wherein the first multiplier attenuates the first output of the first sound production channel by a first controllable factor to produce a first output;
wherein the second multiplier attenuates the second output of the first sound production channel by a second controllable factor to produce a second output;
wherein the third multiplier attenuates the first output of the second sound production channel by a third controllable factor to produce a third output;
wherein the fourth multiplier attenuates the second output of the second sound production channel by a fourth controllable factor to produce a fourth output;
wherein the first combiner combines the first and the third outputs to produce an output transmitted to the first audio outlet; and
wherein the second combiner combines the second and the fourth outputs to produce an output transmitted to the second audio outlet.

14. The electronic instrument according to claim 13, wherein the first audio outlet connects to a headphone.

15. The electronic instrument according to claim 14, wherein the second audio outlet connects to a speaker.

16. The electronic instrument according to claim 13, wherein the first audio outlet connects to a first headphone and wherein the second audio outlet connects to a second headphone.

17. A method of operating an electronic instrument, the method comprising:
assigning a first sound production channel to a first key of the electronic instrument;
assigning a second sound production channel to a second key of the electronic instrument;
attenuating a first output of the first sound production channel by a first controllable factor to produce a first output;
attenuating a second output of the first sound production channel by a second controllable factor to produce a second output;
attenuating a first output of the second sound production channel by a third controllable factor to produce a third output;
attenuating a second output of the second sound production channel by a fourth controllable factor to produce a fourth output;
combining the first and the third outputs to produce an output for transmittal to a first audio outlet of the electronic instrument; and
combining the second and the fourth outputs to produce an output for transmittal to a second audio outlet of the electronic instrument.

18. The method according to claim 17, wherein the first audio outlet connects to a headphone.

19. The method according to claim 18, wherein the second audio outlet connects to a speaker.

20. The method according to claim 17, wherein the first audio outlet connects to a first headphone and wherein the second audio outlet connects to a second headphone.
